(19) United States
(12) Patent Application Publication
(10) Pub. No.: US 2026/0326340 A1
(43) Pub. Date: Oct. 22, 2026

(54) Process for Producing a Woodbase Material Board Provided with a Flame Retardant

(71) Applicant: SWISS KRONO Tec AG, Luzern (CH)

(72) Inventors: Norbert Kalwa, Horn-Bad Meinberg (DE); Andreas Gier, Mandelbachtal (DE); Georg Seidack, Wittstock/Dosse (DE)

(21) Appl. No.: 19/105,625

(22) PCT Filed: Aug. 24, 2023
(86) PCT No.: PCT/EP2023/073300

§ 371 Date: Feb. 21, 2025

(30) Foreign Application Priority Data
Aug. 31, 2022 (EP) 22193242.9

(51) Int. Cl. B27N 9/00; B27N 3/02; C09D 5/18

(52) U.S. Cl. CPC B27N 9/00; B27N 3/02; C09D 5/18

(57) ABSTRACT

A method of manufacturing a wood-based panel, wherein at least one flame retardant is applied to the wood particles in the form of an aqueous suspension during the manufacturing process. The aqueous flame retardant suspension includes at least one phosphate salt and/or at least one sulfate, a mixture of at least one compound of the general formula (I) R¹ₐSiX₍₄₋ₐ₎, whereby X is alkoxy, and R¹ is an organic moiety selected from the group consisting of alkyl, cycloalkyl or phenyl, and a=1, 2, 3, at least one compound of the general formula (II) SiX₄⁻, whereby X is alkoxy, and at least one compound of the general formula (III) R²SiX₃, whereby X is alkoxy, and R² is an organic moiety selected from the group comprising C1-C10 alkyl, which may be interrupted by —O— or —NH—, and wherein R² comprises at least one functional moiety Q₁.

### CROSS-REFERENCE TO RELATED APPLICATIONS

This application is the United States national phase of International Patent Application No. PCT/EP2023/073300 filed Aug. 24, 2023, and claims priority to European Patent Application No. 22193242.9 filed Aug. 31, 2022, the disclosures of each of which are hereby incorporated by reference in their entireties.

### BACKGROUND

### Technical Field

The disclosure relates to a method for producing a wood-based panel provided with a flame retardant and wood-based panels comprising this flame retardant.

### Technical Considerations

In recent years, there have been a number of serious fires in buildings, some of which have claimed considerable numbers of victims. This has led to stricter legal regulations regarding fire protection. At the same time, however, certain flame retardants have also been banned or their use strictly regulated due to ecological or health concerns (e.g., boron salts). In addition to the resulting stricter requirements regarding the flammability/combustibility of products in certain applications, there is also a demand for flame-retardant products in many applications where fire protection is not relevant. This also applies to wood-based materials that are used either in the structural area for walls, floors or ceilings (prefabricated house construction) or in the decorative area for laminate flooring, furniture, panels, etc. area. OSB (oriented strand board), plywood and chipboard are used in the construction sector and MDF/HDF (medium density fiberboard/fiberboard with increased bulk density) and chipboard in the decorative sector.

Inorganic salts are usually used in the production of flame-retardant wood-based materials. These are almost exclusively sulphates (sulfates), phosphates and/or polyphosphates as ammonium salts. The reason for this is that these salts provide particularly good results in terms of flame retardancy. These salts must be used in solutions with relatively high concentrations, as otherwise additional problems are caused by the water contained in the salt suspensions used, so that the water must be removed from the process.

While it is relatively easy to incorporate the flame retardant (FSM) into the wood matrix in the production of flame-retardant particleboard or fiberboard, there are problems with adding it to the OSB strands. Strands are the coarse chips used in the production of OSB.

Originally a waste product from the veneer and plywood industry, OSB is increasingly being used in timber and prefabricated house construction, as OSB is lightweight and still meets the structural requirements placed on building boards. OSBs are used as building boards and as wall or roof cladding or even for flooring.

OSB is manufactured in a multi-stage process, whereby the chips or strands of debarked round wood, preferably softwood, are first peeled off lengthwise using rotating knives. In the subsequent drying process, the natural moisture of the strands is reduced at high temperatures. The moisture content of the strands can vary depending on the adhesive used, although the moisture content should be well below 10% in order to avoid splitting due to excessive vapor pressure in the board during subsequent pressing. Depending on the adhesive, wetting may be more favorable on moist strands or on dry strands.

After the strands have dried, they are fed into a gluing device in which the glue or adhesive is finely distributed onto the chips. PMDI (polymeric diphenylmethane diisocyanate) or MUPF (melamine-urea-phenol-formaldehyde) glues are predominantly used for gluing. The glues can also be mixed in the OSB. These glues are used because, as mentioned above, OSBs are often used for structural applications. Glues that are resistant to moisture or wetness must be used there.

After gluing, the glued strands are spread alternately lengthwise and crosswise to the production direction in spreading devices so that the strands are arranged crosswise in at least three layers (lower top layer-middle layer-upper top layer). The spreading direction of the lower and upper surface layer is the same, but differs from the spreading direction of the middle layer. The strands used in the top layer and middle layer also differ from each other. For example, the strands used in the top layers are flat and the strands used in the middle layer are less flat or even chip-shaped. Usually, two strands of material are used in the production of OSB: one with flat strands for the subsequent surface layers and one with “chips” for the middle layer. Accordingly, the strands in the middle layer can be of poorer quality, as the bending strength is essentially generated by the surface layers. For this reason, fines produced during machining can also be used in the middle layer of OSB boards. Once the strands have been spread, they are continuously pressed under high pressure and at a high temperature of 200 to 250° C., for example.

The OSB strands used in production have a surface that makes it difficult for the aqueous solution of the flame retardant to penetrate. This means that after the water has evaporated, the flame retardant is essentially on the strands as a powder, not bound. As the strands rub against each other until they are scattered by the transport device, some of the flame retardant is rubbed off the strands. The flame retardant is subsequently lost in the process or is found in areas of the OSB where it plays no role in flammability. As a result, the dosage has to be increased, which causes additional costs. This is noticeable, for example, in the fact that the flame retardant is only dosed in the top layer, but is later also found in the middle layer of the product. In addition, the increased amount of flame retardant must be taken into account with more glue, as the flame retardant interferes with the gluing process.

Furthermore, the production of flame-retardant wood-based panels in general and OSB in particular is very complex, as approx. 20% by weight of flame retardant must be added to the wood of the panel. It should be noted that considerable quantities of product have to be discarded at the beginning and end of production because the required amount of flame retardant is not yet or no longer in the strands. This also leads to increased costs and makes the process inflexible, as the largest possible quantities of flame-retardant sheets must always be produced in order to keep the losses low in relation to the production quantity.

Furthermore, the solutions of the flame retardant usually contain approx. 50% by weight of flame retardant. Higher concentrations are only possible by heating the solutions, which is not technically possible in many systems. This also places a limit on the dosing quantity due to the amount of water that is introduced into the system, as excessive amounts of water lead to excessive vapor pressure in the plate and thus to splitting. Of course, this also means that the highly concentrated flame retardant is distributed more poorly on the strands than with a less concentrated solution.

Another problem is that steam injection systems are now installed upstream of the presses to increase production speed. This superheated steam ensures that the strand cake is preheated and thus the temperature required for curing the glue used, such as PMDI glue, is reached more quickly. This steam, which is applied to the strands at high pressure, naturally also washes away some of the flame retardant from the strands.

This results in disadvantages, in particular higher costs, greater losses and an inflexible process.

### SUMMARY

The disclosure is based on the technical object of solving the problems described above. If possible, this should be done without making any major changes to the process. The solution should also not cause any other problems, e.g., by adding critical ingredients or solvents. Any solutions used should also be compatible with the flame retardant used.

This object is solved by a method for producing a wood-based panel provided with a flame retardant, having features as described herein.

### DETAILED DESCRIPTION

Accordingly, in some non-limiting embodiments, a method for manufacturing a wood-based panel made of wood particles is provided, wherein at least one flame retardant is applied to the wood particles in the form of an aqueous suspension during the manufacturing process, and wherein the aqueous flame retardant suspension comprises the following components:
at least one phosphate salt and/or sulfate, and
   a mixture of at least one compound of the general formula (I)

R¹ₐSiX₍₄₋ₐ₎ (I),
whereby
   X is alkoxy, and
   R¹ is an organic moiety selected from the group comprising alkyl, cycloalkyl or phenyl, and
   a=1, 2, 3, preferably 1 or 2,
at least one compound of the general formula (II)

SiX₄ (II),
where X is alkoxy, and
   at least one compound of the general formula (III)

R²_{b}SiX₃ (III),
whereby
   X is alkoxy, and
   R² is an organic moiety selected from the group comprising C1-C10 alkyl, which may be interrupted by —O— or —NH—, and
   wherein R² has at least one functional moiety Q₁ which is selected from a group containing a methacrylic, methacryloxy, vinyl and/or epoxy group,
   b=1, 2, 3, preferably 1 or 2.

Accordingly, in some non-limiting embodiments, a composition comprising at least one phosphate and/or sulfate and a silane mixture for use in wood-based panels is provided, wherein the silanes the silane mixture used act as a fixing agent for the phosphate and/or sulphate on the wood particles used for the wood-based panels; i.e., the silanes are used as a fixing agent for the flame retardant on the wood particles. This is intended to prevent or reduce the rubbing off/falling off of the flame retardant after application to the wood particles, such as strands or chips, until the wood particles are pressed into wood-based panels. For this purpose, the silane mixture of three different silanes is added to the flame retardant before dosing onto the wood particles. This can done in the storage tank or before the flame retardant is applied to the wood particles.

The silanes react with the flame retardant on the one hand and with the surface of the wood particles on the other. Due to their reactivity with the wood surface, the silane compounds improve the adhesion of the phosphate and/or sulfate to the wood surface of the wood particles. The silane compound of formula (I) binds to the flame retardant via the organic moieties. The silane compound of formula (II) is used to build up a SiO₂-network via condensation of the OH groups. The alkyl moieties, such as methyl, of the silane compound of formula (I) cause a “loosening” of the three-dimensional SiO₂ network, which is formed by condensation. More flexible network structures are formed that are not too brittle. The silane compound of formula (III) has at least one functional moiety, such as isocyanate or glycidyl groups, for chemical bonding to free OH groups of the cellulose on the wood particle surface.

The use of the present composition as a flame retardant offers various advantages. For example, a more precise dosing of the flame retardant and thus a reduction in the amount of flame retardant required is possible, which can reduce the cost of the flame retardant. It also enables better material utilization.

In some non-limiting embodiments, the (hydrolyzable) moiety X of the silane compounds of formulae (I)-(III) is advantageously selected from a group comprising C₁₋₆-alkoxy, for example methoxy, ethoxy, n-propoxy, i-propoxy and/or butoxy. Methoxy and/or ethoxy are preferred.

In some non-limiting embodiments, the organic moiety R¹ of the compound of the general formula (I) is preferably selected from a group comprising C1-C10 alkyl, preferably C1-C8 alkyl, preferably methyl, ethyl, propyl, pentyl, hexyl, heptyl, and/or octyl. The term “cycloalkyl” comprises the groups cyclopropyl, cyclobutyl, cyclopentyl, cyclohexyl and/or cycloheptyl.

In some non-limiting embodiments, the compound of the general formula (I) may comprise one of the following formulae: R¹SiX₃ or R¹₂SiX₂ with R¹ as C1-C10 alkyl group, preferably methyl, ethyl, propyl, pentyl, hexyl, heptyl, and/or octyl, and with X as alkoxy, for example methoxy, ethoxy, n-propoxy and/or i-propoxy.

In some non-limiting embodiments, of the present composition, compounds of the general formula (I) according to R¹ₐSiX₍₄₋ₐ₎, for example R¹SiX₃, may be selected from methyltriethoxysilane, phenyltriethoxysilane, dimethyldiethoxysilane, and/or octyltriethoxysilane.

In some non-limiting embodiments, of the present composition, the compound of the general formula (II) SiX₄ comprises methoxy, ethoxy, n-propoxy or i-propoxy and/or butoxy, as X.

Preferred are the compounds tetramethoxysilane and/or tetraethoxysilane as the compound of the general formula (II).

In some non-limiting embodiments, the organic moiety R² of the compound of the general formula (III) is preferably selected from a group comprising methyl, ethyl, propyl, pentyl, hexyl, heptyl, and/or octyl, which may be interrupted by —O— or —NH—.

In some non-limiting embodiments of the present composition, the at least one functional moiety Q¹ of the compound of general formula (III) is selected from a group comprising epoxy, methacryloxy, amino, and/or vinyl. A preferred functional moiety Q¹ is glycidyloxy. The functional moiety Q¹ advantageously has a residue with a double bond or an epoxide group which can be activated and polymerized by means of UV radiation.

The functional moieties, via which crosslinking with the wood surface of the wood particles is possible, comprise polymerizable and/or polycondensable groups, whereby the polymerization reaction is also to be understood as polyaddition reactions. The functional groups are preferably selected in such a way that organic crosslinking between the phosphate and/or sulphate as flame retardant and the wood surface can be carried out via optionally catalyzed polymerization and/or condensation reactions.

In some non-limiting embodiments of the present composition, the compound of general formula (III) comprises methoxy, ethoxy, n-propoxy or i-propoxy and/or butoxy, as X, preferably methoxy and ethoxy.

Preferred are the compounds glycidyoxypropyltriethoxysilane and/or glycidyoxypropyltrimethyoxysilane as a compound of the general formula (III).

According to some non-limiting embodiments, the composition comprises a silane mixture in which a first compound of formula (I) R¹ₐSiX₍₄₋ₐ₎ where a=1, where X is methoxy, ethoxy, n-propoxy and/or i-propoxy, R¹ is methyl, ethyl, n-propyl or n-butyl, a second compound of formula (II) SiX₄ where X is alkoxy, for example methoxy, ethoxy, n-propoxy and/or i-propoxy, and a third compound of the formula (III) R²_{b}SiX₃ where b=1, where X is methoxy, ethoxy, n-propoxy and/or i-propoxy, R² is methyl, ethyl, n-propyl or n-butyl and Q is a glycidyl or glycidyloxy group.

Other silanes which do not fall under one of the formulae (I)-(III) are not part of the composition according to the present disclosure and are thus excluded.

In some non-limiting embodiments of the present composition, the silane mixture comprises 5 to 25% by weight, or preferably 10 to 20% by weight, of at least one silane of formula (1), 3 to 15% by weight, or preferably 6 to 11% by weight, of at least one silane of formula (II) and 5 to 20% by weight, or preferably 8 to 15% by weight, of at least one silane of formula (III).

In some non-limiting embodiments, the silane mixture comprises 5 to 15% by weight, or preferably 8 to 12% by weight, of at least one silane of formula (1), 3 to 10% by weight, or preferably 4 to 7% by weight, of at least one silane of formula (II) and 10 to 20% by weight, or preferably 13 to 17% by weight, of at least one silane of formula (III).

In another non-limiting embodiment, the silane mixture comprises 15 to 25% by weight, or preferably 18 to 22% by weight, of at least one silane of formula (I), 5 to 15% by weight, or preferably 10 to 13% by weight, of at least one silane of formula (II) and 5 to 10% by weight, or preferably 7 to 9% by weight, of at least one silane of formula (III).

In some non-limiting embodiments of the present composition, the at least one phosphate is a monophosphate and/or polyphosphate and is used as an ammonium salt and/or organic salt. Preferred are halogen-free phosphates, such as ammonium polyphosphate. Preferably, a mixture of phosphates and sulfates is used.

In some non-limiting embodiments, the present composition comprises at least one metal alkoxide, for example a zirconium alkoxide, such as zirconium n-propoxide. Preferably, the amount of metal alkoxide is 1 to 3% by weight, or 1 to 2% by weight. The alkoxides used serve as a condensation catalyst in order to have the highest possible degree of condensation even at low temperatures.

In some non-limiting embodiments, the present composition comprises at least one glycol ether. The glycol ether is added to the composition as a mixture of water and at least one glycol ether, for example in a mixing ratio of 60 parts water and 40 parts glycol ether. The glycol ethers used are dipropylene glycol monomethyl ether, tripropylene glycol monomethyl ether, 1-methoxy-2-propanol, tripropylene glycol monobutyl ether, propylene glycol butyl ether, and/or ethylene glycol monophenyl ether, preferably dipropylene glycol monomethyl ether. Glycol ethers serve as a non-flammable solvent that goes well with both the water of the flame retardant and the alcohol of the silane. If a glycol ether is used, the alcohol step in the production of the flame retardant can be omitted, as shown below.

In some non-limiting embodiments, the present composition comprises
at least one phosphate and/or sulphate,
at least one compound of the general formula (I) according to R¹SiX₃ or R¹₂SiX₂ with R¹ as C1-C10 alkyl group, preferably methyl, ethyl, propyl, pentyl, hexyl, heptyl, octyl, and/or with X as alkoxy, for example methoxy, ethoxy, n-propoxy and/or i-propoxy;
at least one compound of the general formula (II) according to SiX₄ with X as methoxy, ethoxy, n-propoxy and/or i-propoxy and/or butoxy;
at least one compound of the general formula (III) according to R²SiX₃ with R² as methyl, ethyl, propyl, pentyl, hexyl, heptyl, or octyl, which may be interrupted by —O— or —NH—, and functionalized with an epoxide or vinyl group as Q1, and X as methoxy, ethoxy, n-propoxy, i-propoxy and/or butoxy; and
at least one metal alkoxide, preferably zirconium alkoxide,
optionally at least one glycol ether, and
water.

In some non-limiting embodiments, the present composition comprises
at least one phosphate and/or sulphate,
at least one compound of the general formula (I) according to R¹SiX₃ or R¹₂SiX₂ with R¹ as methyl, ethyl, and/or propyl, and with X as methoxy, and/or ethoxy;
at least one compound of the general formula (II) according to SiX₄ with X as methoxy, and/or ethoxy;
at least one compound of the general formula (III) according to R²SiX₃ with R² as ethyl, propyl, or pentyl, which may be interrupted by —O— or —NH—, and functionalized with an epoxide or vinyl group as Q1, and X as methoxy, and/or ethoxy; and
at least one metal alkoxide, preferably zirconium alkoxide,
optionally at least one glycol ether, and
water.

In some non-limiting embodiments, the present composition may comprise inorganic particles, for example nanoparticles based on SiO₂, such as silica gels or zeolites. The particles preferably used have a size of 2 to 400 nm, preferably of 2 to 100 nm, more preferably of 2 to 50 nm. By adding the inorganic particles, the amount of active ingredient absorbed can be further increased.

In some non-limiting embodiments, the present flame retardant can be prepared in a process comprising the following steps:
a) providing an aqueous suspension comprising at least one compound of the general formula (I), at least one compound of the general formula (II) and at least one compound of the general formula (III);
b) adding at least one catalyst, for example a basic compound, to the suspension of at least one compound of the formula (I), of the formula (II) and of the formula (III);
c) heating the mixture of at least one compound of the formula (I), the formula (II) and the formula (III) and the at least one catalyst;
d) adding at least one metal alkoxide, for example a zirconium alkoxide, to the mixture, and
e1) either separating the alcoholic phase formed (e.g., by evaporation) from the aqueous phase of the mixture of at least one compound of formula (I), of formula (II) and of formula (III), or
e2) adding a mixture of water and at least one glycol ether, and
f) adding of at least one phosphate and/or sulphate to the mixture obtained in step e1) or step e2).

Basic compounds such as alkaline solutions like NaOH, KOH or ammonium hydroxide solutions are suitable as catalysts. Preferably, a sodium hydroxide solution is used, for example a 0.1 molar sodium hydroxide solution.

In some non-limiting embodiments, in step f) 20 to 40 wt %, or preferably 25 to 35 wt %, or more preferably 30 wt % of the mixture obtained in step e 1) or step e 2) is added to an aqueous phosphate solution, for example a phosphate solution having a solids content of 50 wt %. The amount of silane mixture in the final composition is preferably 2 to 10 wt %, or preferably 3 to 8 wt %, or more preferably 4 to 6 wt %, e.g., 5 wt %.

The prepared aqueous suspension of the flame retardant consisting of three silanes and phosphate and/or sulphate is stable and is applied to the wood particles in the form of a spray. The flame retardant is applied during the manufacturing of a wood-based panel.

According to some non-limiting embodiments, a method of manufacturing a wood-based panel is also provided, comprising the following steps:
Providing wood particles; for example dried wood particles;
Gluing the wood particles with a suitable binding agent, and
Pressing the glued wood particles into a wood-based panel,
   wherein the at least one flame retardant composition described above is applied, for example sprayed, to the wood particles before, with or after the binder is applied to the wood particles.

The amount of flame retardant composition sprayed onto the wood particles is 15 to 30 wt %, or preferably 20 to 25 wt % (solid on wood atro).

Preferred binders are selected from the group comprising formaldehyde adhesives, polyurethane adhesives, epoxy resin adhesives, and/or polyester adhesives, whereby mainly formaldehyde adhesives are used.

In some non-limiting embodiments, a phenol-formaldehyde resin adhesive (PF), a cresol/resorcinol-formaldehyde resin adhesive, urea-formaldehyde resin adhesive (UF) and/or melamine-formaldehyde resin adhesive (MF) can be used as a formaldehyde adhesive.

Polyurethane adhesives based on aromatic polyisocyanates, for example polydiphenylmethane diisocyanate (PMDI), toluene diisocyanate (TDI) and/or diphenylmethane diisocyanate (MDI), with PMDI being preferred, can be used to a lesser extent as an alternative to formaldehyde adhesives.

In addition to the binder, in some non-limiting embodiments, paraffines (e.g., 3 wt % of a 50 wt % paraffin emulsion) are also added to the wood particles to reduce water absorption and swelling. The paraffin emulsion is preferably sprayed onto the wood particles.

The wood-based panels produced can be an OSB (oriented strand board), a chipboard or a plywood panel.

In some non-limiting embodiments, OSB boards are produced, the method comprising the following steps:
a) Production of strands (OSB strands) from suitable timber,
b) Temporary storage of the wood strands, for example in silos or bunkers,
c) Drying the wood strands,
d) Sorting or sifting the wood strands according to the size of the wood strands,
e) Gluing the wood strands with a suitable binder, for example with at least one isocyanate;
f) placing the glued wood strands on a conveyor belt by means of wind and/or throw sifting, and
g) Pressing the glued wood strands arranged on the conveyor belt.
   wherein the at least one flame retardant composition described herein is applied, for example sprayed, to the wood strands before, with or after the binder is applied to the wood strands.

As mentioned above, oriented strand boards (OSB) are manufactured from long strands in a multi-stage process.

In a first step, strands of debarked round wood, preferably softwood, are peeled off lengthwise using rotating knives.

The wooden strands produced in this way can have a length of 50 to 200 mm, or preferably 70 to 180 mm, or preferably 90 to 150 mm; a width of 5 to 50 mm, or preferably 10 to 30 mm, or preferably 15 to 20 mm; and a thickness of 0.1 to 2 mm, or preferably of 0.3 to 1.5 mm, or preferably of 0.4 to 1 mm.

In some non-limiting embodiments, for example, the wood strands have a length of 150 to 200 mm, a width of 15 to 20 mm, a thickness of 0.5 to 1 mm and a maximum moisture content of 50%.

OSB typically consists of two surface layers bordering a middle layer, whereby the surface layers and middle layer can consist of different types of wood strands. For example, flat strands can be used in the surface layers, while lower quality strands (or even chips) can be used in the middle layer. It is preferable if the strands for the top layers are mixed, e.g., sprayed, with the flame retardant present.

Isocyanates are preferably used as binders for OSB. In some non-limiting embodiments, the at least one isocyanate is based on aromatic polyisocyanates, for example polydiphenylmethane diisocyanate (PMDI), toluene diisocyanate (TDI) and/or diphenylmethane diisocyanate (MDI), with PMDI being preferred. However, melamine-urea-formaldehyde glues or phenolic glues can also be used. Like PMDI, these also have high water resistance. Melamine is also used as a flame retardant.

As already indicated, the at least one flame retardant can be applied to the wood strands in a gluing drum (coil) or a trough mixer together with the addition of the binder, for example by spraying.

A gluing device used for the present process in the form of a coil consists of a cylinder and at least one supply bar for the supply of adhesive and compressed air with spray discs, for the drive of which pneumatic drive motors arranged in housings are provided. Such a gluing device is described in DE 10 2008 046 637A 1.

A suitable trough mixer is sold by Dieffenbacher, for example. Such glue mixers ensure uniform glue distribution thanks to their large chamber volume and the optimum dwell time of the material. To ensure an optimum gluing result, the constant filling level of the mixer is maintained by an outlet flap.

The flame retardant composition can be used in both the surface layers and the middle layer, or only in the surface layers or only in the middle layer of the OSB.

After applying the binder with the flame retardant to the wood strands, the glued wood strands are placed on a conveyor belt or spread and then pressed into an OSB wood-based panel.

Pressing can take place at a pressing temperature of 150 to 250° C., or preferably of 180° C. to 220° C., and a pressing time of 30 to 240 seconds, or preferably of 100 to 210 seconds, or preferably of 150 to 180 seconds.

The OSBs produced by the present process thus comprise a binder and the flame retardant composition described above.

It was found that the content of flame retardants on the strands after spreading and pressing in the OSB was increased by up to 70% when the silane mixtures were used as fixatives compared to samples without fixatives.

The coarse particle boards (OSB) produced using the method described have a transverse tensile strength of greater than 0.3 N/mm², or preferably greater than 0.4 N/mm², or preferably greater than 0.45 N/mm², or preferably greater than 0.5 N/mm². The transverse tensile strength can be in a range of 0.3 to 0.6 N/mm², or preferably of 0.4 to 0.6 N/mm², or preferably of 0.45 to 0.55 N/mm².

Furthermore, the coarse particle boards (OSB) produced using the process described have moduli of elasticity in the longitudinal direction of 3200 to 4000 MPa, or preferably of 3400 to 3800 MPa, and moduli of elasticity in the transverse direction of 1400 to 1800 MPa, or preferably of 1500 to 1600 MPa.

The present OSB wood-based panel can have a bulk density of 300 to 1000kg/m³, or preferably of 500 to 800 kg/m³, or preferably of 600 and 700kg/m³.

The thickness of the present OSB wood-based panel can be 5 to 50 mm, or preferably 8 to 40 mm, with a thickness of 8 to 30 mm being preferred.

As mentioned above, it is also possible to produce chipboard using this process.

According to some non-limiting embodiments, a method of manufacturing particleboard is provided, comprising the following steps:
a) Production of wood chips from suitable wood,
b) Shredding the wood chips by chipping to obtain wood shavings;
c) Gluing the wood chips with at least one binding agent;
d) Applying the glued wood chips to a conveyor belt to form a multi-layer chip cake; and
e) Pressing the chipboard into a wood-based panel.
   wherein the at least one flame retardant composition described above is applied, for example sprayed, to the wood chips before, with or after the binder is applied to the wood chips.

The wood chips produced in the machining process are divided into fine and coarse chip material, whereby the larger wood chips are preferably used in the middle layer of the chipboard and the smaller wood chips are preferably used in the surface layers. It is preferable if the wood chips for the top layers are mixed with the flame retardant present, e.g., sprayed.

In the case of particleboard, formaldehyde-based binders are preferably used, with binder quantities of 5 to 8% by weight, or preferably of 6 to 7% by weight, being used for the middle layer and of 6 to 10% by weight, or preferably of 8 to 9% by weight, being used for the top layer. When using a polyurethane-based binder, such as PMDI, in particleboard, the amount of binder in the middle layer is 2 to 5 wt %, or preferably 3 wt %, and in the top layer 4 to 8 wt %, or preferably 5 wt %.

After gluing, the glued wood chips are spread onto a conveyor belt to form a chip cake. In the case of wood chips, wind spreading is usually used, whereby a first top layer is spread first, followed by the middle layer and finally a second top layer.

The chip cake is then first pre-pressed and then hot-pressed at temperatures of 100° C. to 250° C., or preferably of 130° C. to 220° C., or at 200° C.

The present wood-based panel in the form of a chipboard can have a bulk density of 400 to 1200 kg/m³, or preferably of 500 to 1000 kg/m³, or preferably of 600 to 800 kg/m³.

The thickness of the present wood-based panel as chipboard can be 3 to 20 mm, or preferably 5 to 15 mm, with a thickness of 10 mm being preferred.

The present particleboard consists of 60 to 90% by weight, or preferably 70 to 80% by weight, of wood chips and 5 to 20% by weight, or preferably 10 to 15% by weight, of binders.

The present disclosure is explained in more detail below using several examples of non-limiting embodiments or aspects.

### Example 1

Added 5 wt % ino® dur GW80-N-D (30 wt %) to a phosphate/polyphosphate-based flame retardant (solids content: approx. 50 wt %).

### Synthesis of the Additive Ino® Dur GW80-N-D

15.23 g glycidyloxypropyltriethoxysilane, 9.75 g methyltriethoxysilane and 5.7 g tetraethoxysilane were hydrolyzed using 1.67 g of a 0.1 molar sodium hydroxide solution.

After a stirring time of 60 minutes at 40° C. under reflux, 2.04 g of zirconium n-propoxide (70% in iso-propanol) was added. After a further stirring time of 60 minutes at room temperature, 8.22 g of water was added and 7.1 g of ethanol was removed using a rotary evaporator (T=55° C. and pₘᵢₙ=105 mbar).

More cost-effective synthesis: Due to price pressure, the solvent exchange step using a rotary evaporator was to be avoided and a more cost-effective silane mixture was to be used. The synthesis was adapted for this purpose:

### Example 2: OSB Flame-Retardant

Added 5 wt % ino® dur GW80-N-D5 (30 wt %) to a phosphate/polyphosphate-based flame retardant (solids content: approx. 50 wt %).

### Synthesis of the Additive Ino® Dur GW80-N-D5

7.61 g glycidyloxypropyltriethoxysilane, 19.5 g methyltriethoxysilane and 11.4 g tetraethoxysilane using 1.92 g of a 0.1 molar sodium hydroxide solution, the silanes were hydrolyzed. After a stirring time of 60 minutes at 40° C. under reflux, 1.24 g of zirconium n-propoxide (70% in iso-propanol) was added.

After a further stirring time of 60 minutes at room temperature, 15.78 g of a mixture consisting of 60 parts water and 40 parts dipropylene glycol methyl ether was added and stirred for a further 30 minutes at room temperature.

The finished additive had a flash point of approx. 60° C. Adding 25% by weight to the aqueous flame retardant (phosphate/polyphosphate) resulted in a flash point well above 70° C. and can therefore be used without replacing the solvent.

This mixture was then sprayed onto the top layer strands for an OSB in a coil (gluing drum) in an amount of 24% by weight (solid on wood atro). Also 5 wt % PMDI (100%) and 3 wt % paraffin emulsion (50 wt %) were dosed. For the middle layer, strands were sprayed in another coil with 3.5 wt % PMDI (100%) and 3 wt % paraffin emulsion (50 wt %). After spreading the strands, strands were removed from the top layer and analyzed for flame retardant content. The result was a value of 21% by weight. Only 15% by weight was found in a zero sample without fixative. The structure was run through a Contipress and pressed under pressure and temperature to form an OSB (22 mm). Board samples were taken behind the press and the flame retardant content was also determined. There, a value of 20 wt % was found for the sample with fixative and a value of 10 wt % for the sample without fixative.

### Example 3: Flame-Retardant Chipboard

A phosphate/polyphosphate-based flame retardant (solids content: approx. 50% by weight) was mixed with 5% by weight of ino® dur GW 80-N-D5 (30% by weight) (production as in Example 2).

This mixture was then sprayed in a mixer onto the surface layer chips for a chipboard in a quantity of 20 % by weight (solid on wood atro). Also 15 wt % urea-formaldehyde glue solid (as 60% solution) and 2 wt % hot paraffin were dosed. The glue contained a hardener based on an ammonium salt in a quantity of 5 wt./fl. (50% solution).

After spreading the top layers and the middle layer (gluing: 7 wt % urea-formaldehyde glue (solid on wood atro, 60% solution with ammonium salt-based hardener (5 wt % fl/on glue fl.)). 2 wt % hot paraffin was also added to the middle layer chips. Gluing was carried out in a trough mixer in the same way as for the top layer.

After spreading the top and middle layers, chips were taken from the top layer and analyzed for the flame retardant content. The result was a value of 16% by weight. Only 13% by weight was found in a zero sample without fixative. The chips were pressed in a Contipress to form a three-layer chipboard (18 mm). Board samples were taken behind the press and the flame retardant content was also determined. There, a value of 15 wt % was found for the sample of the surface layer with fixing agent and a value of 12 wt % for the sample without fixing agent.

1. A method of manufacturing a wood-based panel, comprising applying at least one aqueous flame retardant suspension to wood particles during the manufacturing process, wherein the at least one aqueous flame retardant suspension comprises:
at least one phosphate salt and/or at least one sulfate,
a mixture of at least one compound of the general formula (I)
R¹ₐSiX₍₄₋ₐ₎ (I),
whereby
X is alkoxy, and
R¹ is an organic moiety independently selected from the group consisting of alkyl, cycloalkyl and phenyl, and
a=1, 2, 3,
at least one compound of the general formula (II)
SiX₄ (II),
whereby X is alkoxy, and
at least one compound of the general formula (III)
R²SiX₃ (III),
whereby
X is alkoxy, and
R² is an organic moiety selected from the group comprising C1-C10 alkyl, which may be interrupted by —O— or —NH—, and
wherein R² comprises at least one functional moiety Q₁ selected from a group comprising a methacrylic, methacryloxy, vinyl and/or epoxy group.

2. The method according to claim 1, wherein X is selected from a group comprising C₁₋₆-alkoxy.

3. The method according to claim 1, wherein R¹ of the compound of the general formula (I) is selected from a group comprising C1-C10 alkyl.

4. The method according to claim 1, wherein the compound of the general formula (I) is R¹SiX₃ or R¹₂SiX₂ with R¹ as C1-C10 alkyl group and with X as alkoxy.

5. The method according to claim 1, wherein R² of the compound of the general formula (III) is selected from a group comprising methyl, ethyl, propyl, pentyl, hexyl, heptyl, or octyl, which may be interrupted by —O— or —NH—.

6. The method according to claim 1, wherein the at least one functional moiety Q¹ of the compound of the general formula (III) is selected from a group comprising epoxide, amino and/or vinyl group.

7. The method according to claim 1, wherein the silane mixture comprises 5 to 25% by weight of at least one silane of formula (I), 3 to 15% by weight of at least one silane of formula (II) and 5 to 20% by weight of at least one silane of formula (III).

8. The method according to claim 1, wherein the at least one phosphate salt is a monophosphate or polyphosphate, or a mixture with a sulphate.

9. The method according to claim 1, wherein at least one glycol ether is present.

10. The method according to claim 1, wherein the at least one aqueous flame retardant suspension further comprises at least one metal alkoxide.

11. The method according to claim 1, wherein the at least one wood-based panel is an oriented strand board (OSB), chipboard or plywood panel.

12. The method according to claim 1, further comprising:
providing the wood particles;
gluing the wood particles with a suitable binding agent,
pressing the glued wood particles into a wood-based panel,
wherein the at least one aqueous flame retardant suspension is applied to the wood particles before, with or after the binding agent is applied to the wood particles.

13. A wood-based panel produced according to the method of claim 1.

14. (canceled)

15. A method for the preparation of the at least one aqueous flame retardant suspension according to claim 1, comprising:
a) providing an aqueous suspension containing a mixture of at least one compound of the general formula (I), at least one compound of the general formula (II) and at least one compound of the general formula (III);
b) adding at least one catalyst to the suspension of at least one compound of the formula (I), of the formula (II) and of the formula (III);
c) heating the mixture of at least one compound of the formula (I), the formula (II) and the formula (III) and the at least one catalyst;
d) adding at least one metal alkoxide to the mixture, and
e1) either separating the alcoholic phase formed from the aqueous phase of the mixture of at least one compound of formula (I), of formula (II) and of formula (III), or
e2) adding a mixture of water and at least one glycol methyl ether, and
f) adding at least one phosphate to the mixture obtained in step e1) or step e2).

16. The method according to claim 2, wherein X is selected from methoxy, ethoxy, n-propoxy, i-propoxy or butoxy.

17. The method according to claim 3, wherein R¹ of the compound of the general formula (I) is selected from methyl, ethyl, propyl, pentyl, hexyl, heptyl, or octyl.

18. The method according to claim 4, wherein the compound of the general formula (I) is R¹SiX₃ or R¹₂SiX₂ with R¹ as methyl, ethyl, propyl, pentyl, hexyl, heptyl, or octyl, and with X as methoxy, ethoxy, n-propoxy or i-propoxy.

19. The method according to claim 7, wherein the silane mixture comprises 10 to 20% by weight of at least one silane of formula (I), 6 to 11% by weight of at least one silane of formula (II) and 8 to 15% by weight of at least one silane of formula (III).

20. The method according to claim 9, wherein the at least one glycol ether is dipropylene glycol monomethyl ether, tripropylene glycol monomethyl ether, 1-methoxy-2-propanol, tripropylene glycol monobutyl ether, propylene glycol butyl ether, and/or ethylene glycol monophenyl ether.

21. The method according to claim 10, wherein the at least one metal alkoxide is a zirconium alkoxide.
